(19) United States
(12) Patent Application Publication
(10) Pub. No.: US 2025/0307156 A1
(43) Pub. Date: Oct. 2, 2025

(54) SYSTEMS AND METHODS FOR CONTROLLING A VEHICLE SYSTEM STARTUP

(71) Applicant: Harman International Industries, Incorporated, Stamford, CT (US)

(72) Inventor: Ivan Iliev IVANOV, Steinhoering (DE)

(73) Assignee: Harman International Industries, Incorporated, Stamford, CT (US)

(21) Appl. No.: 19/233,328

(22) Filed: Jun. 10, 2025

Related U.S. Application Data
(63) Continuation of application No. PCT/US2022/053925, filed on Dec. 23, 2022.

(51) Int. Cl. G06F 12/0837; G06F 12/02

(52) U.S. Cl. CPC G06F 12/0837; G06F 12/0246

(57) ABSTRACT

A method includes storing, by a microcontroller, cache data of the microcontroller into a dynamic random-access memory (DRAM) in response to the microcontroller receiving a power-off command. The method includes operating, by a DRAM controller, the DRAM in a standby state in response to the microcontroller storing the cache data into the DRAM. The method includes determining, by the DRAM controller and when the DRAM is operating in the standby state, a time characteristic associated with the DRAM, a charge characteristic associated with the DRAM, or a combination thereof. The method includes determining, by the DRAM controller, whether a suspend to storage condition is satisfied based on the time characteristic, the charge characteristic, or the combination thereof. The method includes storing, by the DRAM controller, the cache data of the DRAM into a read-only memory (ROM) in response to the suspend to storage condition being satisfied.

### FIELD

The present disclosure relates to systems and method for controlling a vehicle system startup.

### BACKGROUND

The statements in this section merely provide background information related to the present disclosure and may not constitute prior art.

Vehicle systems may include one or more dynamic random-access memories (DRAMs) that are employed by a microcontroller to perform various vehicle functions. As an example, vehicle infotainment and/or cockpit systems may include one or more DRAMs having 16, 24, or 32 gigabytes (GB) of storage that are employed by a microcontroller to perform vehicle infotainment and/or cockpit system routines.

Moreover, the vehicle infotainment and/or cockpit systems may need to access the data of the DRAM with predefined speed and energy efficiencies as the routines executed by the microcontroller increase in complexity. To access the data in accordance with the predefined speed and/or energy efficiencies, the vehicle infotainment and/or cockpit systems may perform a “suspend to ram” routine after receiving a power-off command to thereby operate the DRAM in a standby state. That is, a microcontroller of the vehicle infotainment and/or cockpit systems moves at least a set of the data employed for performing various routines into the DRAM until the vehicle receives a power-on command, and the DRAM is supplied with electrical energy from a power source to refresh the data until the vehicle receives the power-on command.

However, the DRAM may only retain the data up until the power source is depleted (e.g., the DRAM can operate in the standby mode between 72 and 80 hours). As such, when the vehicle infotainment and/or cockpit systems receive the power-on command after the power source is depleted, the resulting initialization/startup of the vehicle infotainment and/or cockpit systems may be a time and resource intensive process due to the data loss. These issues with the DRAM operating in the standby state, among other issues, are addressed by the present disclosure.

### SUMMARY

This section provides a general summary of the disclosure and is not a comprehensive disclosure of its full scope or all of its features.

The present disclosure provides a method for managing cache data stored by a vehicle control system. The method includes storing, by a microcontroller, the cache data of the microcontroller into a dynamic random-access memory (DRAM) in response to the microcontroller receiving a power-off command. The method includes operating, by a DRAM controller, the DRAM in a standby state in response to the microcontroller storing the cache data into the DRAM, where the DRAM is operable in the standby state, an on state, and an off state. The method includes determining, by the DRAM controller and when the DRAM is operating in the standby state, a time characteristic associated with the DRAM, a charge characteristic associated with the DRAM, or a combination thereof. The method includes determining, by the DRAM controller, whether a suspend to storage condition is satisfied based on the time characteristic, the charge characteristic, or the combination thereof. The method includes storing, by the DRAM controller, the cache data of the DRAM into a read-only memory (ROM) in response to the suspend to storage condition being satisfied.

In variations of the method of the above paragraph, which may be implemented individually or in any combination, the method further includes determining, by the microcontroller, whether a power-on command is received; and obtaining, by the microcontroller, the cache data from the ROM in response to the suspend to storage condition being satisfied. In one embodiment, the method further includes obtaining, by the microcontroller, the cache data from the DRAM in response to the suspend to storage condition not being satisfied. In one embodiment, the method further includes performing, by the microcontroller, one or more infotainment control routines in response to obtaining the cache data from one of the DRAM and the ROM. In one embodiment, the time characteristic indicates an amount of time the DRAM operates in the standby state; and the suspend to storage condition is satisfied in response to the amount of time being greater than a threshold amount of time. In one embodiment, the charging characteristic indicates an amount of electrical charge of the DRAM; and the suspend to storage condition is satisfied in response to the amount of electrical charge being less than a threshold amount of electrical charge. In one embodiment, the ROM has a sequential read speed of at least 4.2 gigabytes per second. In one embodiment, the ROM has a sequential write speed of at least 2.8 gigabytes per second. In one embodiment, the method further includes performing a bootloader routine in response to the microcontroller receiving a power-on command and the DRAM operating in the off state. In one embodiment, the method further includes performing a suspend to DRAM routine in response to the microcontroller receiving a power-on command and the DRAM operating in the standby state.

The present disclosure provides a vehicle control system comprising a dynamic random-access memory (DRAM), where the DRAM is operable in a standby state, an on state, and an off state. The vehicle control system includes a DRAM controller, a microcontroller, and a read-only memory (ROM). The DRAM, the DRAM controller, the microcontroller, and the ROM are communicably coupled to each other. The microcontroller is configured to store cache data of the microcontroller into the DRAM in response to the microcontroller receiving a power-off command. The DRAM controller is configured to operate the DRAM in one of the off state and the standby state in response to the microcontroller receiving the power-off command. The DRAM controller is configured to determine, when the DRAM is operating in the standby state, a time characteristic associated with the DRAM, a charge characteristic associated with the DRAM, or a combination thereof. The DRAM controller is configured to determine whether a suspend to storage condition is satisfied based on the time characteristic, the charge characteristic, or the combination thereof. The DRAM controller is configured to store the cache data of the DRAM into the ROM in response to the suspend to storage condition being satisfied.

In variations of the method of the above paragraph, which may be implemented individually or in any combination, the microcontroller is further configured to determine whether a power-on command is received; and obtain the cache data from the ROM in response to the suspend to storage condition being satisfied. In one embodiment, the microcontroller is further configured to obtain the cache data from the DRAM in response to the suspend to storage condition not being satisfied. In one embodiment, the microcontroller is further configured to perform one or more infotainment control routines in response to obtaining the cache data from one of the DRAM and the ROM. In one embodiment, the time characteristic indicates an amount of time the DRAM operates in the standby state; and the suspend to storage condition is satisfied in response to the amount of time being greater than a threshold amount of time. In one embodiment, the charging characteristic indicates an amount of electrical charge of the DRAM; and the suspend to storage condition is satisfied in response to the amount of electrical charge being less than a threshold amount of electrical charge. In one embodiment, the ROM has a sequential read speed of at least 4.2 gigabytes per second. In one embodiment, the ROM has a sequential write speed of at least 2.8 gigabytes per second. In one embodiment, the microcontroller is further configured to perform a bootloader routine in response to the microcontroller receiving a power-on command and the DRAM operating in the off state. In one embodiment, the microcontroller is further configured to perform a suspend to DRAM routine in response to the microcontroller receiving a power-on command and the DRAM operating in the standby state.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various embodiments thereof, given by way of example, reference being made to the accompanying drawings, in which:

FIG. 1 is a functional block diagram of an example vehicle in accordance with the teachings of the present disclosure;

FIG. 2 is a functional block diagram of an example vehicle control system in accordance with the teachings of the present disclosure;

FIG. 3 is a flowchart illustrating an example control routine for managing cache data stored by a vehicle control system in accordance with the teachings of the present disclosure;

FIG. 4A is a flow diagram illustrating example subroutine of a control routine for managing cache data stored by a vehicle control system in accordance with the teachings of the present disclosure;

FIG. 4B is a flow diagram illustrating another example subroutine of the control routine of FIG. 4A in accordance with the teachings of the present disclosure;

FIG. 4C is a flow diagram illustrating another example subroutine of the control routine of FIG. 4A in accordance with the teachings of the present disclosure; and

FIG. 4D is a flow diagram illustrating another example subroutine of the control routine of FIG. 4A in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a vehicle system having a DRAM, a DRAM controller, a microcontroller, and a read-only memory (ROM), where the ROM has a sequential read speed of at least 4.2 gigabytes per second and a sequential write speed of at least 2.8 gigabytes per second. The microcontroller is configured to store cache data of the microcontroller into the DRAM in response to the DRAM operating in the standby state. The DRAM controller is configured to operate the DRAM in one of the off state and the standby state in response to the microcontroller receiving a power-off command. When the DRAM is operating in the standby state, DRAM controller is configured to determine a time characteristic associated with the DRAM, a charge characteristic associated with the DRAM, or a combination thereof and determine whether a “suspend to storage” condition is satisfied. The DRAM controller moves the cache data from the DRAM into the ROM in response to the suspend to storage condition being satisfied.

By performing the “suspend to storage” routine (i.e., storing the cache data of the DRAM into the ROM in response to the “suspend to storage” condition being satisfied) as described herein, the data employed by the vehicle control system can be stored by the vehicle control system for an increased period of time, such as beyond the depletion of the power source coupled to the DRAM. Furthermore, the microcontroller may obtain the data with increased speed and efficiency in response to receiving a power-on command, as described below in further detail.

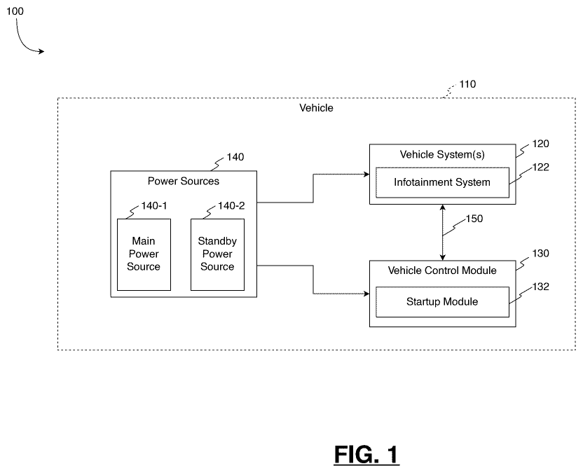

Referring to FIG. 1, an environment 100 is shown and generally includes a vehicle 110. In one embodiment, the vehicle 110 includes one or more vehicle systems 120, one or more electronic control modules (ECMs) 130, a plurality of power sources 140, and a vehicle interface 150 that communicably couples the one or more ECMs 130 and the one or more vehicle systems 120. As an example, the vehicle interface 150 may include a controller area network (CAN) bus, a local interconnect network (LIN) bus, and/or a clock extension peripheral interface (CXPI) bus for exchanging data and signals between the one or more ECMs 130 and the one or more vehicle systems 120.

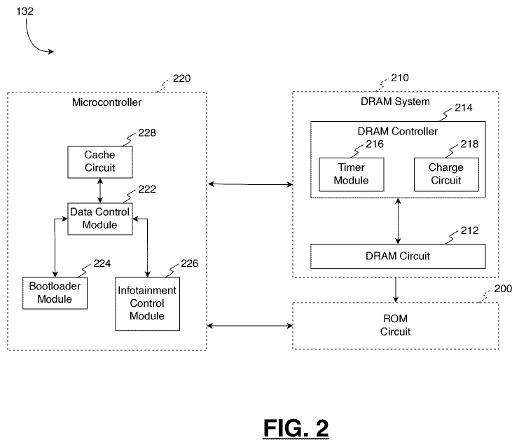

The one or more ECMs 130 are configured to control and/or monitor the one or more vehicle systems 120. As an example, the ECMs 130 may include a startup module 132 configured to control one or more functions of an infotainment system 122 from among the one or more vehicle systems 120. In one embodiment, the infotainment system 122 includes various components for performing infotainment control routines, such as a display device of the infotainment system, one or more navigation modules, one or more vehicle-to-vehicle or vehicle-to-infrastructure cellular connectivity modules, among others. Additional details regarding the startup module 132 are provided below with reference to FIG. 2. While the startup module 132 is shown as part of the infotainment system 122, it should be understood that the startup module 132 may be provided as part of various other types of vehicle systems and is not limited to the example described herein, such as a cockpit system, an internal combustion control system, a powertrain control system, a transmission control system, a brake control system, a body control system, a climate control system, a suspension control system, and/or other types of vehicle systems.

The power sources 140 may be provided by energy storage apparatuses, such as a battery of the vehicle 110, that are configured to provide electrical energy to various components of the vehicle 110, such as the one or more ECMs 130 and the one or vehicle systems 120. As an example, the plurality of power sources 140 include a main power source 140-1 that is configured to provide the electrical energy when the vehicle 110 is powered on. As another example, the plurality of power sources 140 include a standby power source 140-2 configured to provide the electrical energy when the vehicle 110 is powered off, where the standby power source 140-2 and the main power source 140-1 have different electrical characteristics (e.g., power outputs, charging times, depletion times, among others). It should be understood that the vehicle 110 may include known electrical interfaces and/or power converter circuits for physically and electrically coupling the power sources 140 to the one or more ECMs 130 and the one or vehicle systems 120.

In one embodiment and with reference to FIG. 2, the startup module 132 may include a read-only memory (ROM) circuit 200, a dynamic random-access memory (DRAM) system 210, and a microcontroller 220 that are communicably coupled to each other via known communication protocols. In one embodiment, the ROM circuit 200 is a non-volatile memory circuit that stores data employed by the microcontroller 220 when performing one or more routines, such as a masked ROM circuit, a programmable ROM circuit, an erasable programmable ROM circuit, or an electrically erasable programmable ROM circuit. In one embodiment, the ROM circuit 200 has a sequential read speed of at least 4.2 gigabytes per second (GB/s), and the ROM circuit 200 has a sequential write speed of at least 2.8 GB/s. As an example, the ROM circuit 200 is a non-volatile memory express (NVMe), solid state drive (SSD) type memory circuit that includes a communication interface and one or more driver circuits that collectively function according to a peripheral component interconnect express (PCIe) standard, such as the PCI4.0 and PCIe 5.0 standards. As another example, the ROM circuit 200 may be a universal flash storage 4.0 (UFS 4.0) or UFS 4.1 type non-volatile memory circuit. It should be understood that the ROM circuit 200 may be provided by various other types of non-volatile memory circuits having a sequential read speed of at least 4.2 GB/s and a sequential write speed of at least 2.8 GB/s and is not limited to the examples described herein.

In one embodiment, the DRAM system 210 includes a DRAM circuit 212 and a DRAM controller 214. In one embodiment, the microcontroller 220 includes a data control module 222, a bootloader module 224, an infotainment control module 226, and a cache circuit 228. In one embodiment, the DRAM circuit 212 is a volatile memory circuit comprising a plurality of addressable memory banks that each include a transistor and a capacitor. The DRAM circuit 212 stores cache data employed by the bootloader module 224 and the infotainment control module 226 while performing, for example, a bootloader routine and an infotainment control routine (described below in further detail), respectively. As an example, each bit of cache data is assigned to and stored in a respective addressable memory bank from among the plurality of addressable memory banks (e.g., 16,000,000,000 addressable memory banks that correspond to an example capacity of the DRAM circuit 212). To store the bit of the cache data, the transistors selectively couple the capacitors to the standby power source 140-2 to thereby obtain a charge, where a charged capacitor indicates a logic high (e.g., a “1”), and where a discharged capacitor indicates a logic low (e.g., a “0”).

In one embodiment, the DRAM circuit 212 is operable in an on state, an off state, and a standby state. As used herein, the “on state” refers to a state in which the microcontroller 220 has received (or is receiving) a power-on command and in which the bootloader module 224 or the infotainment control module 226 are performing the bootloader routine or the infotainment control routine, respectively. The power-on command may include, but is not limited to, an operator of the vehicle 110 turning on the vehicle 110 and/or activating an ignition system of the vehicle 110. As used herein, the “standby state” refers to a state in which the microcontroller 220 has received (or is receiving) a power-off command, and in which the DRAM controller 214 performs the “suspend to ram” routine, which is described below in further detail. The power-off command may include, but is not limited to, an operator of the vehicle 110 turning off the vehicle 110 and/or deactivating an ignition system of the vehicle 110. As used herein, the “off state” refers to a state in which the microcontroller 220 has received the power-off command, the DRAM controller 214 is unable to perform the “suspend to ram” routine due to the depletion of electrical energy from the standby power source 140-2, and the DRAM controller 214 has performed (or begins to perform) the “suspend to storage” routine. That is, the DRAM circuit 212 loses the cache data stored therein due to the depletion of electrical energy of the standby power source 140-2 that is employed for refreshing the addressable memory banks of the DRAM circuit 212.

When the DRAM circuit 212 transitions from the on state to the standby state, the microcontroller 220 and the DRAM controller 214 collectively initiate the “suspend to ram” routine. That is, the data control module 222 retrieves the cache data from the cache circuit 228, provides the cache data to the DRAM controller 214, which in turn stores the cache data in the DRAM circuit 212. Furthermore, the DRAM controller 214 periodically refreshes the addressable memory banks of the DRAM circuit 212 to preserve/maintain the cache data by selectively coupling the capacitors to the standby power source 140-2 via the transistors, as described above.

When the DRAM circuit 212 is operating in the standby state, the DRAM controller 214 is configured to determine a time characteristic associated with the DRAM circuit 212, a charge characteristic associated with the DRAM circuit 212, or a combination thereof. In one embodiment, the time characteristic indicates an amount of time the DRAM circuit 212 has been operating in the standby state. To perform the functionality described herein, the DRAM controller 214 may include a timer module 216 configured to incrementally increase a timer value thereof while the DRAM circuit 212 is operating in the standby state. Furthermore, the DRAM controller 214 may include a charge circuit 218 configured to measure an amount of electrical charge of capacitors of the DRAM circuit 212 (e.g., a sense amplifier circuit) and/or the standby power source 140-2 (e.g., a voltage, current, and/or electrical power/energy sensor).

The DRAM controller 214 determines whether a “suspend to storage” condition is satisfied based on a comparison of the charge characteristic to a threshold charge characteristic and/or the time characteristic and/or the time characteristic and stores the cache data in the ROM circuit 200 when the “suspend to storage” condition is satisfied. As an example, the DRAM controller 214 determines that the “suspend to storage” condition is satisfied when the amount of electrical charge (as indicated by the charging characteristic) is less than a threshold amount of electrical charge. In one embodiment, the threshold amount of electrical charge may correspond to a predefined voltage level of the capacitors for preserving and/or maintaining the accuracy of the data stored by the given capacitor. As another example, the DRAM controller 214 determines that the “suspend to storage” condition is satisfied when the amount of time (as indicated by the time characteristic) is greater than a threshold amount of time. In one embodiment, the threshold amount of time may correspond to an amount of time for depleting the standby power supply 140-2 as it provides an electrical charge (i.e., the refresh signals) to the DRAM circuit 212 (e.g., 72 hours, 80 hours, among other predefined time values).

The data control module 222 is configured to selectively store the cache data employed by the bootloader module 224 and the infotainment control module 226 in one of the cache circuit 228, the DRAM circuit 212, and the ROM circuit 200. As an example, and as described above, when the DRAM circuit 212 operates in the standby mode and performs the “suspend to ram” routine, the data control module 222 provides the cache data to the DRAM circuit 212 via the DRAM controller 214.

As another example, the data control module 222 is configured to obtain the cache data from the ROM circuit 200 and store the cache data in the cache circuit 228 when the “suspend to storage” condition is satisfied and in response to receiving the power-on command. Subsequently, the bootloader module 224 may perform the bootloader routine (e.g., known booting routines for turning on and initializing the microcontroller 220) when the data control module 222 stores the cache data into the cache circuit 228.

As an additional example, the data control module 222 is configured to obtain the cache data from the DRAM 212 and store the cache data in the cache circuit 228 in response to the “suspend to storage condition” not being satisfied and in response to response to receiving the power-on command (i.e., the DRAM circuit 212 operates in the standby state). Subsequently, the infotainment control module 226 may perform the infotainment control routine when the data control module 222 stores the cache data into the cache circuit 228 (e.g., an image/video display routine for displaying, via a display device of the infotainment system 122, vehicle settings and/or controls of the vehicle 110, navigation instructions of the vehicle 110, connectivity settings of the vehicle 110, among others).

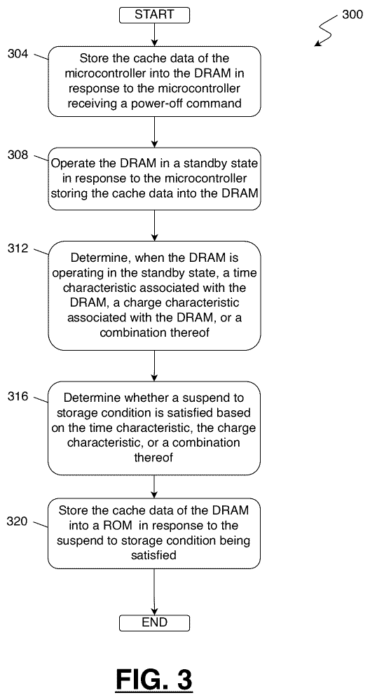

Referring to FIG. 3, a flowchart illustrating an example routine 300 for managing cache data stored by a vehicle control system (e.g., the startup module 132) is shown. At 304, the routine 300 stores the cache data of the microcontroller 220 into the DRAM circuit 212 in response to the microcontroller 220 receiving the power-off command. At 308, the DRAM controller 214 operates the DRAM circuit 212 in a standby state in response to the microcontroller storing the cache data into the DRAM circuit 212. That is, at 308, the microcontroller 220 and the DRAM controller 214 perform the “suspend to RAM” routine.

At 312, the DRAM controller 214 determines, when the DRAM circuit 212 is operating in the standby state, a time characteristic associated with the DRAM circuit 212, a charge characteristic associated with the DRAM circuit 212, or a combination thereof. At 316, the DRAM controller 214 determines whether a suspend to storage condition is satisfied based on the time characteristic, the charge characteristic, or the combination thereof. At 320, the DRAM controller 214 stores the cache data of the DRAM circuit 212 into the ROM circuit 200 in response to the “suspend to storage” condition being satisfied. That is, at step 320, the DRAM controller 214 performs the “suspend to storage” routine.

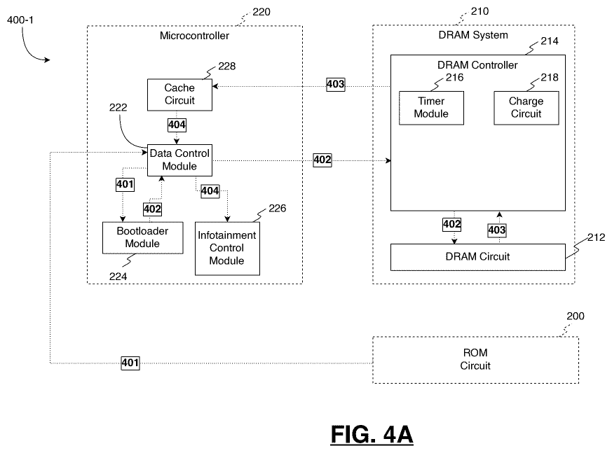

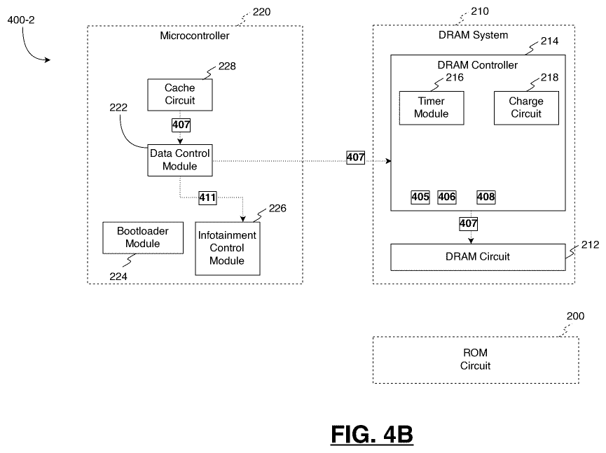

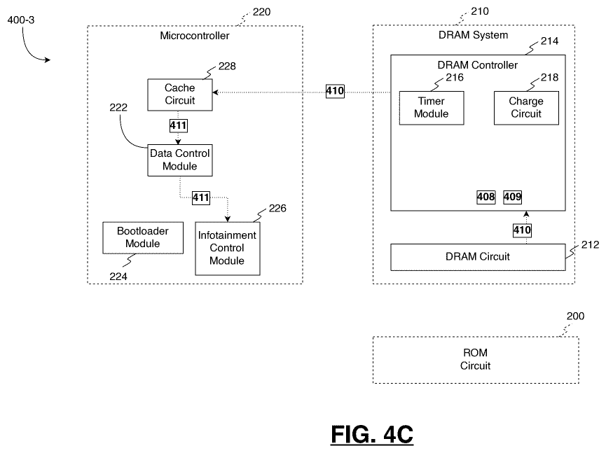

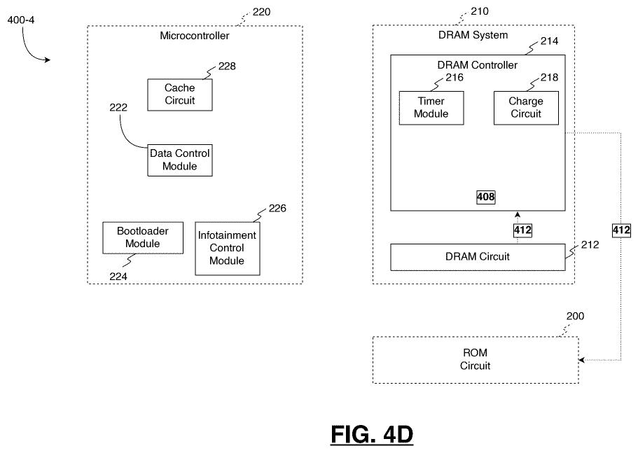

Referring to FIGS. 4A-4D, a flow diagram illustrating an example subroutines 400-1, 400-2, 400-3, 400-4 (collectively referred to hereinafter as “the routine 400”) for managing cache data stored by a vehicle control system (e.g., the startup module 132) is shown. In FIGS. 4A-4B, each of the example steps of the routine 400 are illustrated as dotted arrows.

Referring to FIG. 4A, the subroutine 400-1 corresponds to a portion of the routine in which the startup module 132 may be performed in response to receiving the power-on command and prior to having performed the infotainment control routines. At step 401, the data control module 222 loads the data from the ROM circuit 200 into the bootloader module 224. At step 402, the bootloader module 224 performs the bootloader routine and provides a copy of the data (hereinafter referred to as the “boot image”) to the DRAM controller 214, which stores the boot image in the DRAM circuit 212. At step 403, the DRAM controller 212 moves the boot image into the cache circuit 228, and the infotainment control module 226 obtains the boot image via the data control module 222 to perform the infotainment control routines at step 404. To perform the functionality described at steps 401-404, the microcontroller 220, the ROM circuit 200, and the DRAM system 210 may collectively perform, for example, known von-Neumann architecture-based booting/startup routines.

Referring to FIG. 4B, the subroutine 400-2 is performed after the subroutine 400-1 and after receiving a power-off command. That is, the subroutine 400-2 corresponds to performing the “suspend to RAM” routine and, optionally, the “suspend to storage” routine. At step 405, the DRAM controller 214 designates the state of the DRAM circuit 212 as operating in the standby state and preserves the data currently stored in the DRAM circuit 212 at step 406. At step 407, the DRAM controller 214 stores the cache data of the cache circuit 228 into the DRAM circuit 212.

At step 408, the DRAM controller 214 continues to perform the “suspend to RAM” routine by refreshing the addressable memory banks of the DRAM circuit 212. Furthermore, at step 408, the DRAM controller 214 determines whether one of (i) a subsequent power-on command is received or (ii) the “suspend to storage” condition being satisfied prior to receiving the subsequent power-on command, as described above. In response to receiving the subsequent power-on command prior to the “suspend to storage” condition being satisfied, the startup module 132 performs the subroutine 400-3 shown in FIG. 4C; otherwise, the startup module 132 performs the subroutine 400-4 shown in FIG. 4D.

Referring to FIG. 4C, in response to receiving the subsequent power-on command prior to the “suspend to storage” condition being satisfied, the DRAM controller 214 designates the DRAM circuit 212 as operating in the on state at step 409 and moves the data from the DRAM circuit 212 to the cache circuit 228 at step 410. At step 411, the data control module 222 provides the cache data to the infotainment control module 226 for performing the infotainment control routines described herein. Referring to FIG. 4D, in response to the “suspend to storage” condition being satisfied prior to receiving the subsequent power-on command, the DRAM controller 214 moves the data from the DRAM circuit 212 to the ROM circuit 200 at step 412 to thereby preserve and maintain the data for the subsequent power-on command.

Based on the foregoing, the following provides a general overview of the present disclosure and is not a comprehensive summary. In a first embodiment A1, a method for managing cache data stored by a vehicle control system includes storing, by a microcontroller, the cache data of the microcontroller into a dynamic random-access memory (DRAM) in response to the microcontroller receiving a power-off command. The method includes operating, by a DRAM controller, the DRAM in a standby state in response to the microcontroller storing the cache data into the DRAM, where the DRAM is operable in the standby state, an on state, and an off state. The method includes determining, by the DRAM controller and when the DRAM is operating in the standby state, a time characteristic associated with the DRAM, a charge characteristic associated with the DRAM, or a combination thereof. The method includes determining, by the DRAM controller, whether a suspend to storage condition is satisfied based on the time characteristic, the charge characteristic, or the combination thereof. The method includes storing, by the DRAM controller, the cache data of the DRAM into a read-only memory (ROM) in response to the suspend to storage condition being satisfied.

In a second embodiment A2, which may include the first embodiment A1, the method further includes determining, by the microcontroller, whether a power-on command is received; and obtaining, by the microcontroller, the cache data from the ROM in response to the suspend to storage condition being satisfied. In a third embodiment A3, which may include any combination of the first through second embodiments A1-A2, the method further includes obtaining, by the microcontroller, the cache data from the DRAM in response to the suspend to storage condition not being satisfied.

In a fourth embodiment A4, which may include any combination of the first through third embodiments A1-A3, the method further includes performing, by the microcontroller, one or more infotainment control routines in response to obtaining the cache data from one of the DRAM and the ROM. In a fifth embodiment A5, which may include any combination of the first through fourth embodiments A1-A4, the time characteristic indicates an amount of time the DRAM operates in the standby state; and the suspend to storage condition is satisfied in response to the amount of time being greater than a threshold amount of time.

In a sixth embodiment A6, which may include any combination of the first through fifth embodiments A1-A5, the charging characteristic indicates an amount of electrical charge of the DRAM; and the suspend to storage condition is satisfied in response to the amount of electrical charge being less than a threshold amount of electrical charge. In a seventh embodiment A7, which may include any combination of the first through sixth embodiments A1-A6, the ROM has a sequential read speed of at least 4.2 gigabytes per second.

In an eighth embodiment A8, which may include any combination of the first through seventh embodiments A1-A7, the ROM has a sequential write speed of at least 2.8 gigabytes per second. In a ninth embodiment A9, which may include any combination of the first through eighth embodiments A1-A8, the method further includes performing a bootloader routine in response to the microcontroller receiving a power-on command and the DRAM operating in the off state. In a tenth embodiment A10, which may include any combination of the first through ninth embodiments A1-A9, the method further includes performing a suspend to DRAM routine in response to the microcontroller receiving a power-on command and the DRAM operating in the standby state.

In an eleventh embodiment A11, a vehicle control system includes a dynamic random-access memory (DRAM), where the DRAM is operable in a standby state, an on state, and an off state. The vehicle control system includes a DRAM controller, a microcontroller, and a read-only memory (ROM). The DRAM, the DRAM controller, the microcontroller, and the ROM are communicably coupled to each other. The microcontroller is configured to store cache data of the microcontroller into the DRAM in response to the microcontroller receiving a power-off command. The DRAM controller is configured to operate the DRAM in one of the off state and the standby state in response to the microcontroller receiving the power-off command. The DRAM controller is configured to determine, when the DRAM is operating in the standby state, a time characteristic associated with the DRAM, a charge characteristic associated with the DRAM, or a combination thereof. The DRAM controller is configured to determine whether a suspend to storage condition is satisfied based on the time characteristic, the charge characteristic, or the combination thereof. The DRAM controller is configured to store the cache data of the DRAM into the ROM in response to the suspend to storage condition being satisfied.

In a twelfth embodiment A12, which may include the eleventh embodiment A11, the microcontroller is further configured to determine whether a power-on command is received and obtain the cache data from the ROM in response to the suspend to storage condition being satisfied. In a thirteenth embodiment A13, which may include any combination of the eleventh through twelfth embodiments A11-A12, the microcontroller is further configured to obtain the cache data from the DRAM in response to the suspend to storage condition not being satisfied. In a fourteenth embodiment A14, which may include any combination of the eleventh through thirteenth embodiments A11-A13, the microcontroller is further configured to perform one or more infotainment control routines in response to obtaining the cache data from one of the DRAM and the ROM.

In a fifteenth embodiment A15, which may include any combination of the eleventh through fourteenth embodiments A11-A14, the time characteristic indicates an amount of time the DRAM operates in the standby state; and the suspend to storage condition is satisfied in response to the amount of time being greater than a threshold amount of time. In a sixteenth embodiment A16, which may include any combination of the eleventh through fifteenth embodiments A11-A15, the charging characteristic indicates an amount of electrical charge of the DRAM; and the suspend to storage condition is satisfied in response to the amount of electrical charge being less than a threshold amount of electrical charge.

In a seventeenth embodiment A17, which may include any combination of the eleventh through sixteenth embodiments A11-A16, the ROM has a sequential read speed of at least 4.2 gigabytes per second. In an eighteenth embodiment A18, which may include any combination of the eleventh through seventeenth embodiments A11-A17, the ROM has a sequential write speed of at least 2.8 gigabytes per second.

In a nineteenth embodiment A19, which may include any combination of the eleventh through eighteenth embodiments A11-A18, the microcontroller is further configured to perform a bootloader routine in response to the microcontroller receiving a power-on command and the DRAM operating in the off state. In a twentieth embodiment A20, which may include any combination of the eleventh through nineteenth embodiments A11-A19, the microcontroller is further configured to perform a suspend to DRAM routine in response to the microcontroller receiving a power-on command and the DRAM operating in the standby state.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for managing cache data stored by a vehicle control system, the method comprising:
storing, by a microcontroller, the cache data of the microcontroller into a dynamic random-access memory (DRAM) in response to the microcontroller receiving a power-off command;
operating, by a DRAM controller, the DRAM in a standby state in response to the microcontroller storing the cache data into the DRAM, wherein the DRAM is operable in the standby state, an on state, and an off state;
determining, by the DRAM controller and when the DRAM is operating in the standby state, a time characteristic associated with the DRAM, a charge characteristic associated with the DRAM, or a combination thereof;
determining, by the DRAM controller, whether a suspend to storage condition is satisfied based on the time characteristic, the charge characteristic, or the combination thereof; and
storing, by the DRAM controller, the cache data of the DRAM into a read-only memory (ROM) in response to the suspend to storage condition being satisfied.

2. The method of claim 1 further comprising:
determining, by the microcontroller, whether a power-on command is received; and
obtaining, by the microcontroller, the cache data from the ROM in response to the suspend to storage condition being satisfied.

3. The method of claim 2 further comprising obtaining, by the microcontroller, the cache data from the DRAM in response to the suspend to storage condition not being satisfied.

4. The method of claim 3 further comprising performing, by the microcontroller, one or more infotainment control routines in response to obtaining the cache data from one of the DRAM and the ROM.

5. The method of claim 1, wherein:
the time characteristic indicates an amount of time the DRAM operates in the standby state; and
the suspend to storage condition is satisfied in response to the amount of time being greater than a threshold amount of time.

6. The method of claim 1, wherein:
the charging characteristic indicates an amount of electrical charge of the DRAM; and
the suspend to storage condition is satisfied in response to the amount of electrical charge being less than a threshold amount of electrical charge.

7. The method of claim 1, wherein the ROM has a sequential read speed of at least 4.2 gigabytes per second.

8. The method of claim 1, wherein the ROM has a sequential write speed of at least 2.8 gigabytes per second.

9. The method of claim 1 further comprising performing a bootloader routine in response to the microcontroller receiving a power-on command and the DRAM operating in the off state.

10. The method of claim 1 further comprising performing a suspend to DRAM routine in response to the microcontroller receiving a power-on command and the DRAM operating in the standby state.

11. A vehicle control system comprising:
a dynamic random-access memory (DRAM), wherein the DRAM is operable in a standby state, an on state, and an off state;
a DRAM controller;
a microcontroller; and
a read-only memory (ROM), wherein:
the DRAM, the DRAM controller, the microcontroller, and the ROM are communicably coupled to each other;
the microcontroller is configured to store cache data of the microcontroller into the DRAM in response to the microcontroller receiving a power-off command;
the DRAM controller is configured to operate the DRAM in one of the off state and the standby state in response to the microcontroller receiving the power-off command;
the DRAM controller is configured to determine, when the DRAM is operating in the standby state, a time characteristic associated with the DRAM, a charge characteristic associated with the DRAM, or a combination thereof;
the DRAM controller is configured to determine whether a suspend to storage condition is satisfied based on the time characteristic, the charge characteristic, or the combination thereof; and
the DRAM controller is configured to store the cache data of the DRAM into the ROM in response to the suspend to storage condition being satisfied.

12. The system of claim 11, wherein the microcontroller is further configured to:
determine whether a power-on command is received; and
obtain the cache data from the ROM in response to the suspend to storage condition being satisfied.

13. The system of claim 12, wherein the microcontroller is further configured to obtain the cache data from the DRAM in response to the suspend to storage condition not being satisfied.

14. The system of claim 13, wherein the microcontroller is further configured to perform one or more infotainment control routines in response to obtaining the cache data from one of the DRAM and the ROM.

15. The system of claim 11, wherein:
the time characteristic indicates an amount of time the DRAM operates in the standby state; and
the suspend to storage condition is satisfied in response to the amount of time being greater than a threshold amount of time.

16. The system of claim 11, wherein:
the charging characteristic indicates an amount of electrical charge of the DRAM; and
the suspend to storage condition is satisfied in response to the amount of electrical charge being less than a threshold amount of electrical charge.

17. The system of claim 11, wherein the ROM has a sequential read speed of at least 4.2 gigabytes per second.

18. The system of claim 11, wherein the ROM has a sequential write speed of at least 2.8 gigabytes per second.

19. The system of claim 11, wherein the microcontroller is further configured to perform a bootloader routine in response to the microcontroller receiving a power-on command and the DRAM operating in the off state.

20. The system of claim 11, wherein the microcontroller is further configured to perform a suspend to DRAM routine in response to the microcontroller receiving a power-on command and the DRAM operating in the standby state.
